(19) United States
(12) Patent Application Publication
(10) Pub. No.: US 2004/0143520 A1
(43) Pub. Date: Jul. 22, 2004

(54) Method of incorporating an internet sales order with fundraising tally data

(76) Inventors: Dennis Barnum, Huntington, IN (US); Sara Phares, Albion, IN (US)

Correspondence Address: Max W. Garwood, 450 N. Jefferson Street, P.O. Box 30, Huntington, IN, 46750, US

(21) Appl. No.: 10/751,576

(22) Filed: Jan. 5, 2004

Related U.S. Application Data
(60) Provisional application No. 60/438,097, filed on Jan. 6, 2003.

(51) Int. Cl. G06F 17/60

(52) U.S. Cl. 705/30; 705/14

(57) ABSTRACT

A fundraising sales method including the steps of receiving a plurality of direct orders for at least one product from a brochure sales presentation; receiving a plurality of internet orders for one of the products or another product; and combining at least one of the plurality of direct orders with at least one of the plurality of internet orders dependent upon one of a plurality of student identifiers.

### CROSS-REFERENCE TO RELATED APPLICATIONS

This is a non-provisional patent application based upon U.S. Provisional Patent application Serial No. 60/438,097 bearing the title “Method of Incorporating an Internet Sales Order with Fund Raising Tally Data” filed on Jan. 6, 2003.

### BACKGROUND OF THE INVENTION

1. Field of the Invention

The present invention relates to a method of combining Internet sales data orders with direct sale orders and, more particularly, to a method of obtaining a sales order on the Internet and combining that with a direct fundraising sale for a student's order, thereby enabling a single computation of prize information for each student/salesperson.

2. Description of the Related Art

Fundraising often takes place in schools that utilize their students to sell items to raise money for the school for its various projects. Often schools utilize fundraising drives to purchase equipment not provided for in a budget, such as band uniforms, playground equipment, enhanced office equipment, and for travel expenses for a particular group. Raising funds is often done on a personal level, where the student provides, to a potential customer, a brochure having various products in it. The customer reviews the brochure, makes selections, and enters an order on an order blank. The student turns his or her order sheets in to a teacher or group leader and the orders are tallied by the fundraising distributor that has organized the sale for the school. The student are grouped into teams, so the order sheets that are provided to the distributor are likewise grouped into teams and the data is entered into a computer program such as Ultra™ or WinUltra™, which was designed and sold by QDP Corporation. WinUltra™ is utilized probably by more fundraising distributors than any other fundraising tallying software. WinUltra™ allows for the organization of student information and organizes the sale by producing team total information as well as calculating prize levels for which each student salesperson and/or a team have achieved. Further, WinUltra™ produces money collection envelopes with information relevant to the sale for each student salesperson, including the prizes won by the student participating in the sale. Further, total information is available to allow teachers or administrators to keep track of a student's sale in the event that the sales amount is used to credit the student toward a personal goal for use toward a benefit to the student, such as for travel.

Internet sales are known in that a purchaser goes to a particular website, selects a product, makes payment arrangements, enters shipping information, the order is processed and product is delivered by way of one of several carriers. Internet auctions and direct sales have been utilized to not only produce revenue for the distributor of the product, but such sales techniques for the fundraising industry have been utilized to raise funds for groups such as schools.

What is needed in the art is a method to coordinate Internet sales and direct sales in the fundraising industry.

### SUMMARY OF THE INVENTION

The present invention provides a method of combining Internet sales data with fundraising data of a direct sale.

The invention comprises, in one form thereof, a fundraising sales method including the steps of receiving a plurality of direct orders for at least one product from a brochure sales presentation; receiving a plurality of internet orders for one of the products or another product; and combining at; least one of the plurality of direct orders with at least one of the plurality of internet orders dependent upon one of a plurality of student identifiers.

The invention comprises, in another form thereof, a fundraising team sales method utilizing the Internet including the steps of entering plurality of team member identifiers into a data storage; associating the plurality of team member identifiers to a plurality of products in the data storage; accessing the data storage by way of the Internet by a customer; selecting one of the plurality of team member identifiers by the customer; and committing to purchase at least one of the plurality of products.

An advantage of the present invention is that an Internet sale can be combined with a direct sale by a salesperson and awards can be determined from the combination of the two sales types.

Another advantage is that total funds raised by each student are calculated dependent upon the total order.

Yet another advantage is that the student enters potential customer email addresses, to which fundraising solicitations are conveyed.

Still yet another advantage of the present invention is that relatives of a student that are not in the same locale may participate in the fundraising event by way of the internet.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram of the steps that a distributor takes, utilizing the method of the present invention;

FIG. 2 is another embodiment of the method of the present invention utilized by the distributor, the student, and the customer; and

FIG. 3 is a block diagram illustrating the method of the present invention that combines information.

Corresponding reference characters indicate corresponding parts throughout the several views. The exemplifications set out herein illustrate preferred embodiments of the invention, and such exemplifications are not to be construed as limiting the scope of the invention in any manner.

### DETAILED DESCRIPTION OF THE PRESENT INVENTION

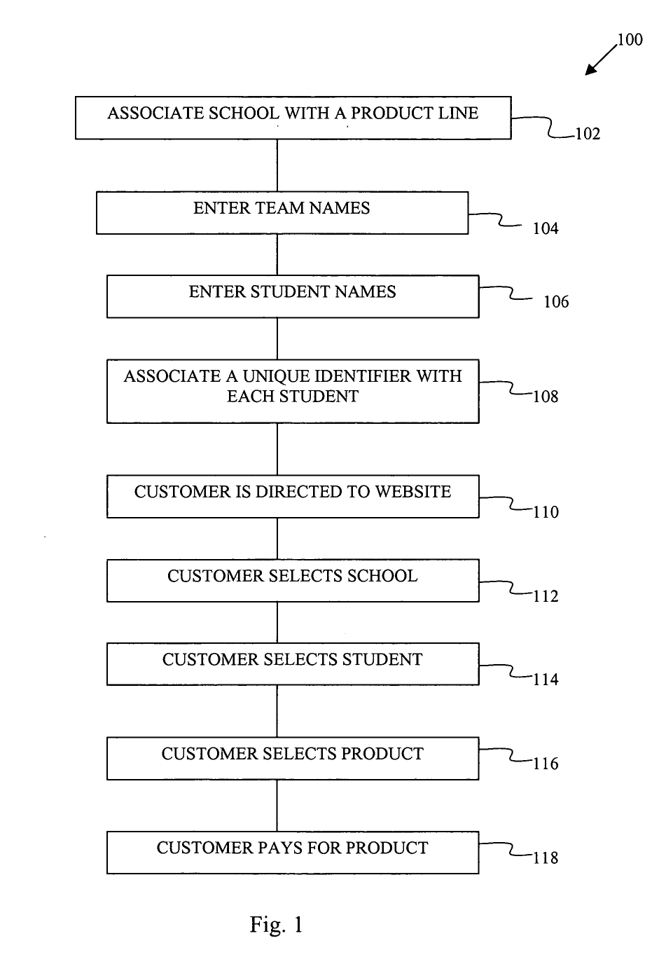

Now, referring to the drawings, and more particularly to FIG. 1, there is shown an embodiment of the present invention. In product fundraising, products are made available to individuals for purchase with a portion of the profits for the support of a group, often a nonprofit organization. In FIG. 1, method 100 includes associating a school with a product line at step 102. Although the term “school” is utilized throughout, any group is equally applicable. The words “school” and “student” are utilized because often fundraising is conducted in the school environment whether associated with the school itself or a group affiliated with the school. Further, each student can be considered a team member of a group, a class or a classroom. As such, other groups and individuals other than students can equally utilize the method of the present invention.

In fundraising, a distributor is associated with a supplier who provides product to the distributor. The distributor contacts the school and arranges for a fundraising drive. The distributor associates within a database the school name or identifier with a particular set of products that has been selected by the school to sell in their fundraiser. The product line may include such items as candies, cookies, small items such as ink pens, money clips, candles, and various small decorating items. The product line that is selected can be provided in brochure format to each student for direct sales to relatives, friends, and parental coworkers. The same product line or a separate product line associated with the brochure can be offered by way of the Internet in the present invention.

In method 100, the distributor enters team names at step 104, which may be associated with the student's class, homeroom, or extracurricular group. The idea of having teams is so that different teams may be in competition in order to enhance the total fundraising drive.

At step 106, the distributor enters the student names that are associated with each team name. This helps to establish the database necessary for later product selection by a customer in order to give a student credit for the sale.

At step 108, method 100 associates a unique identifier with each student name that has been entered at step 106.

At step 110, customers are directed to a website to select product, giving credit to an individual student for the sale thereof. The customer selects the school at step 112, then selects a student that is to get the credit at step 114, then selects product at step 116 from the product line selected at step 102.

At step 118, the customer pays for the product and provides delivery information, such as an address, so that a common carrier can deliver the product.

This method advantageously allows a student in one area of the country to contact relatives living in another area of the country to participate in the fundraiser. This is particularly necessary in our mobile society in which students may be some distance from grandparents and other relatives, and even non-custodial parents.

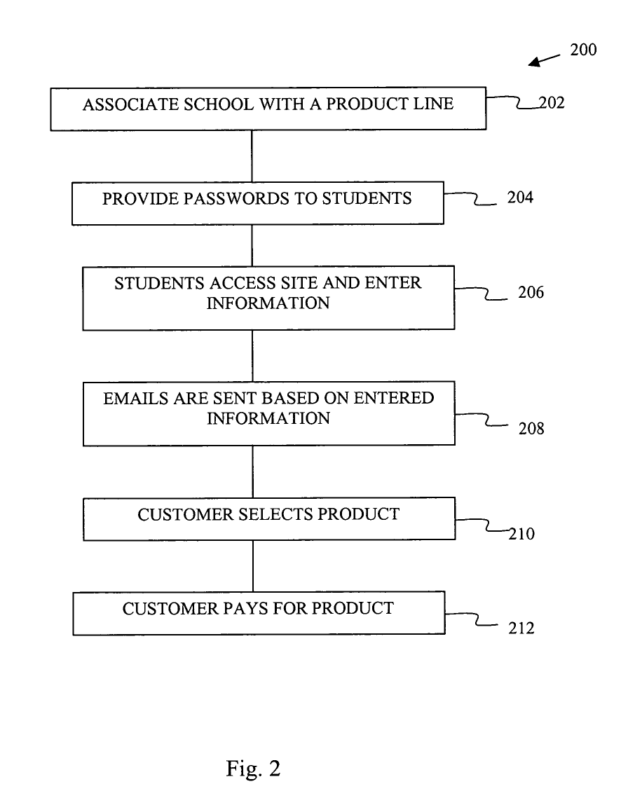

Now, additionally referring to FIG. 2, there is shown another embodiment of a portion of the present invention in the form of method 200. Method 200 includes step 202, where a distributor associates a school group with a product line.

At step 204, the distributor provides the school with passwords to be distributed to students wherein students then access an Internet website and utilize the password, identifying the student to the school and a selected team, wherein the student accesses and enters information at step 206. Information entered includes information about the student for identification purposes and limits any privacy information being gathered, so that only the necessary information is gathered to facilitate the fundraising drive. Information that the student would enter would include the e-mail addresses of individuals that the student would want to be contacted relative to the sale.

At step 208, e-mails are sent to individuals, identifying that a student of the school has requested their participation in a fundraising drive. These e-mails are sent based upon the data entered by the student at step 206. The e-mails include a link to the website, which directs the customer directly to the product line, which is selected at step 210. The customer selects product from the product line, the credit for the sale being assigned to the student.

At step 212, the customer pays for product, providing delivery information and payment arrangements such as credit card information for the payment and then delivery of the selected products.

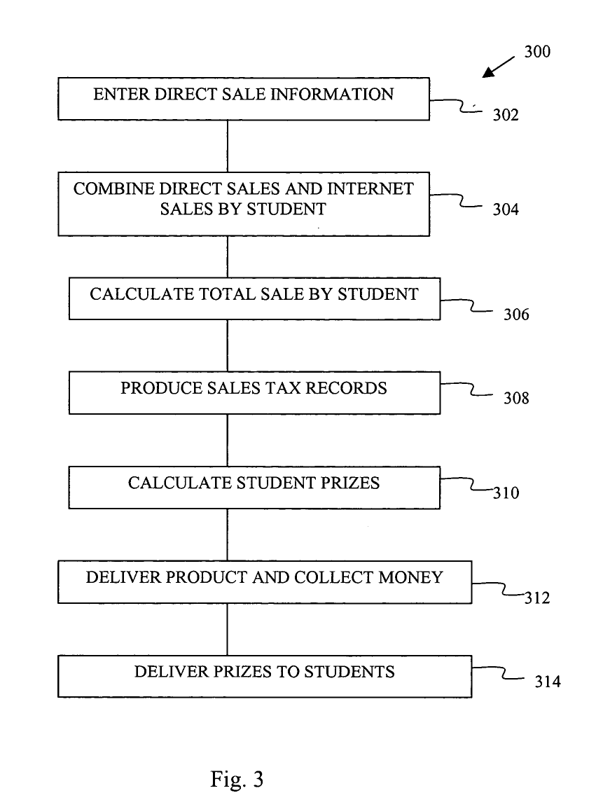

Now, additionally referring to FIG. 3, there is shown method 300, which embodies part of the present invention. Method 300 continues from a preceding method, such as method 100 or 200. Information in the form of completed brochures that reflect the sales handled directly by the student, normally in a face-to-face situation, is provided to the distributor in the form of filled-out paper records. These records are entered into a computer database at step 302.

At step 304, method 300 combines the direct sales entered at step 302 with Internet sales that have been attributed to each student as a result of a previous method such as method 100 or 200. The students' unique identifiers correlate this information in order to credit each student with the sales generated directly and by way of the Internet. The identifiers may be an alphanumeric code, a portion of the student's name or a combination thereof.

At step 306, the total sale by student is calculated in the form of the number of products as well as the dollar value. The product count, as well as the total sale, may be utilized to determine the prize that each student is capable of selecting. Additionally, prize weights by product are utilized to determine the prize categories that are available to each student. For example, one item that sells for a higher amount than another item may be associated with a prize value of twice that of the first item. This allows credit to the student with a higher prize value if the higher-valued products are sold.

At step 308, method 300 produces sales tax records that are necessary in some states for direct sales of certain types of product. Additionally, sales tax liabilities for Internet sales are accounted for in order for the school and distributor to appropriately comply with sales tax requirements. For example if in-state sales are made, whether directly or by way of the Internet, a different set of sales tax laws may apply than to an out of state sale.

At step 310, student prizes are calculated dependent upon the combined direct and Internet sales at step 304.

At step 312, product that has been identified on brochures and by Internet purchase is delivered and money is collected. Since a portion of the money is collected directly—for example, by an Internet sale involving a credit card—and some money is to be collected upon delivery by the student, the present invention accounts for the incremental collection of the funds, allowing the school to have oversight in the collection of funds for the sale of the product.

At step 314, at the end of the fundraising drive, prizes are delivered to students dependent upon the calculated student prizes, which is further dependent upon the combination of the direct sales and Internet sales per student at step 304.

Although the term “prizes” has been utilized in the foregoing, the fundraising drive may not have utilized prizes but rather may have associated earnings to each student to credit the student toward a class trip or similar benefit.

While this invention has been described with respect to preferred embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fundraising team sales method utilizing the internet, comprising the steps of:
entering a plurality of team member identifiers into a data storage;
associating said plurality of team member identifiers to a plurality of products in said data storage;
accessing said data storage via the internet by a customer;
selecting one of said plurality of team member identifiers by said customer; and
committing to purchase at least one of said plurality of products, thereby defining an internet purchased product.

2. The method of claim 1, further comprising the step of combining direct sales information with said internet purchased product.

3. The method of claim 2, further comprising the step of calculating prizes won by at least one of said plurality of team members.

4. The method of claim 2, further comprising the step of generating sales tax records relative to at least one state.

5. The method of claim 2, further comprising the step of delivering said internet purchased product directly to said customer and direct sales product by way of at least one of said plurality of team members.

6. The method of claim 1, further comprising the step of entering a plurality of email addresses corresponding to potential customers.

7. The method of claim 6, wherein said entering step is completed by at least one of said plurality of team members.

8. The method of claim 1, further comprising the step of calculating a total sale associated with said one of said plurality of team member identifiers.

9. The method of claim 1, further comprising the step of providing a plurality of passwords to a plurality of team members, each of said plurality of team members associated with a unique one of said team member identifiers, each of said plurality of passwords uniquely associated with a corresponding one of said plurality of team members.

10. A fundraising sales method, comprising the steps of:
receiving a plurality of direct orders for at least one product from a brochure sales presentation;
receiving a plurality of internet orders for one of said at least one product and an other product; and
combining at least one of said plurality of direct orders with at least one of said plurality of internet orders dependent upon one of a plurality of student identifiers.

11. The method of claim 10, further comprising the step of calculating prizes won by at least one student.

12. The method of claim 10, further comprising the step of generating sales tax records relative to at least one state.

13. The method of claim 10, further comprising the step of delivering said internet purchased product directly to said customer and direct sales product by way of at least one student associated with a corresponding one of said student identifiers.

14. The method of claim 10, further comprising the step of entering a plurality of email addresses associated with potential customers.

15. The method of claim 14, wherein said entering step is completed by at least one student.

16. The method of claim 10, further comprising the step of calculating a total sale associated with said one of said plurality of student identifiers.

17. The method of claim 10, further comprising the step of providing a plurality of passwords to a plurality of students, each of said plurality of students associated with a unique one of said student identifiers, each of said plurality of passwords uniquely associated with a corresponding one of said plurality of student identifiers.
